(19) United States
(12) Patent Application Publication
(10) Pub. No.: US 2026/0227814 A1
(43) Pub. Date: Aug. 6, 2026

(54) PROPORTIONAL TO ABSOLUTE TEMPERATURE (PTAT) CURRENT AND/OR VOLTAGE GENERATOR WITH IMPROVED LINEARITY

(71) Applicant: QUALCOMM Incorporated, San Diego, CA (US)

(72) Inventors: Adithyaa VENKATASUBRAMANIAN, San Diego, CA (US); Kevin Jia-Nong WANG, Poway, CA (US)

(21) Appl. No.: 19/043,301

(22) Filed: Jan. 31, 2025

(51) Int. Cl. G05F 3/26; G01K 7/16

(52) U.S. Cl. CPC G05F 3/262; G01K 7/16

(57) ABSTRACT

Apparatus including a FET including a first source coupled to a first voltage rail, a first gate, and a first drain; a second FET including a second drain, a second gate coupled to the first drain of the first FET, and a second source coupled to a second voltage rail; a first resistor coupled between the second gate and the second drain of the second FET; a third FET including a third source coupled to the first voltage rail, a third gate coupled to the first gate of the first FET, and a third drain; a fourth FET including a fourth drain and gate coupled together, and a fourth source coupled to the second voltage rail; a second resistor coupled between the third drain of the third FET and the fourth drain and fourth gate of the fourth FET; and a control circuit coupled to first and second nodes.

### FIELD

This disclosure relates generally to proportional to absolute temperature (PTAT) current and/or voltage generators used in integrated circuits (ICs) such as system on chips (SOCs), and in particular, to a PTAT current and/or voltage generator (e.g., a temperature sensor) with improved linearity.

### BACKGROUND

A temperature sensor is used in integrated circuits (ICs) and other circuits to generate a voltage or current that varies with temperature. For example, a temperature sensor may be based on a proportional-to-absolute-temperature (PTAT) voltage and/or current generator. It may be preferred for the temperature sensor to generate an output voltage that tracks temperature in a linear manner for calibration purpose.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus, includes: a first field effect transistor (FET) (e.g., M3) including a first source coupled to a first voltage rail (e.g., VDD), a first gate, and a first drain; a second FET (e.g., M1) including a second drain, a second gate coupled to the first drain of the first FET (e.g., M3), and a second source coupled to a second voltage rail (e.g., ground); a first resistor (e.g., R3) coupled between the second gate and the second drain of the second FET (e.g., M1); a third FET (e.g., M4) including a third source coupled to the first voltage rail (e.g., VDD), a third gate coupled to the first gate of the first FET (e.g., M3), and a third drain; a fourth FET (e.g., M2) including a fourth drain and a fourth gate coupled together, and a fourth source coupled to the second voltage rail (e.g., ground); a second resistor (e.g., R1) coupled between the third drain of the third FET (e.g., M4) and the fourth drain and fourth gate of the fourth FET (e.g., M2); and a control circuit (e.g., 510) configured to cause a first voltage (e.g., V₁) at a first node (e.g., n1) between the first FET (e.g. M3) and the first resistor (e.g., R3) to be substantially the same as a second voltage (e.g., V₂) at a second node (e.g., n2) between the third FET (e.g., M4) and the second resistor (e.g., R1).

Another aspect of the disclosure relates to a method. The method, includes: generating a first current through a first field effect transistor (FET) (e.g., M3), a first resistor (e.g., R3), and a second FET (e.g., M1), wherein the first resistor (e.g., R3) is coupled between a gate and a drain of the second FET (e.g., M1); generating a second current through a third FET (e.g., M4), a second resistor (e.g., R1), and a fourth FET (e.g., M2), wherein the fourth FET (e.g., M2) includes drain and gate coupled together; and providing a control voltage to gates of the first and third FETs (e.g., M3 and M4) to control a first voltage (e.g., V₁) at a first node (e.g., n1) between the first FET (e.g., M3) and the first resistor (e.g., R3) and a second voltage (e.g., V₂) at a second node (e.g., n2) between the third FET (e.g., M4) and the second resistor (e.g., R1).

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1A illustrates a block diagram of an example proportional to absolute temperature (PTAT) current and/or voltage generator (e.g., a temperature sensor) in accordance with an aspect of the disclosure.

FIG. 1B illustrates a graph of an output voltage versus temperature associated with the PTAT temperature sensor of FIG. 1A in accordance with another aspect of the disclosure.

FIG. 2A illustrates a block diagram of another example proportional to absolute temperature (PTAT) current and/or voltage generator (e.g., a temperature sensor) in accordance with another aspect of the disclosure.

FIG. 2B illustrates a graph of an output voltage versus temperature associated with the PTAT temperature sensor of FIG. 2A in accordance with another aspect of the disclosure.

FIG. 3 illustrates a block diagram of another example proportional to absolute temperature (PTAT) current and/or voltage generator (e.g., a temperature sensor) in accordance with another aspect of the disclosure.

FIG. 4 illustrates a block diagram of another example proportional to absolute temperature (PTAT) current and/or voltage generator (e.g., a temperature sensor) in accordance with another aspect of the disclosure.

FIG. 5 illustrates a block diagram of another example proportional to absolute temperature (PTAT) current and/or voltage generator (e.g., a temperature sensor) in accordance with another aspect of the disclosure.

FIG. 6 illustrates a flow diagram of an example method of generating a proportional to absolute temperature (PTAT) voltage in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. The term “substantially” means that the associated parameter may not be exact as indicated but accounts for some variation due to specified tolerances.

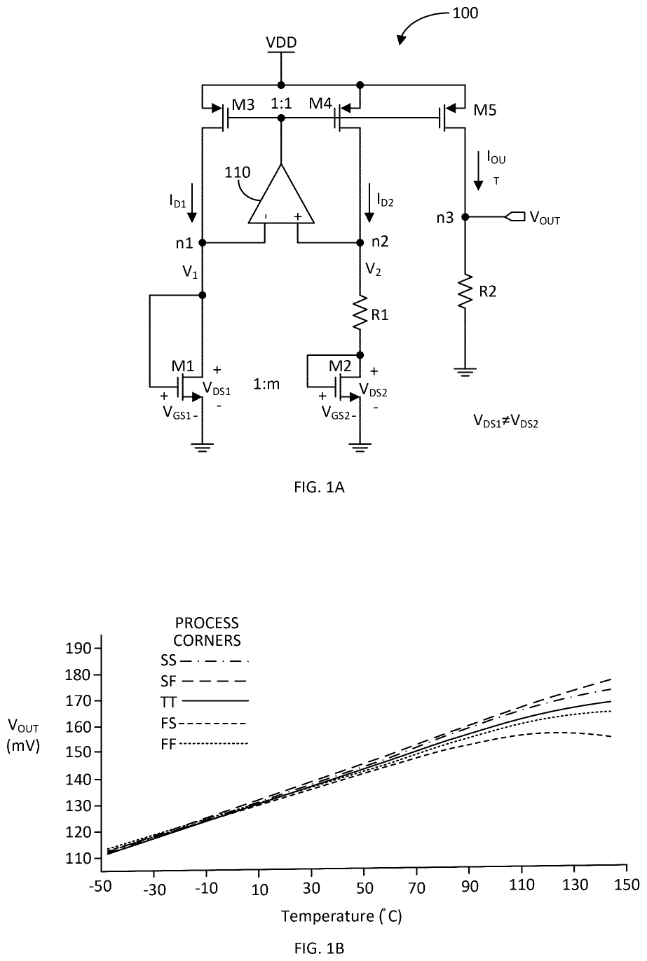

FIG. 1A illustrates a block diagram of an example proportional to absolute temperature (PTAT) current and/or voltage generator 100 in accordance with an aspect of the disclosure. The PTAT current and/or voltage generator 100 may be implemented as a temperature sensor or other device. For explanation herein, the temperature sensor serves as one example of the PTAT current and/or voltage generator 100. The PTAT current and/or voltage generator 100 is configured to generate a proportional to absolute temperature (PTAT) output voltage V_{OUT}, which may be used as an indication of temperature of an integrated circuit (IC) or region (e.g., certain core) of an IC.

In particular, the PTAT current and/or voltage generator 100 includes n-channel field effect transistors (NFETs) M1 and M2, p-channel field effect transistors (PFETs) M3, M4, and M5, resistors R1 and R2, and operational amplifier (OpAmp) 110. The PFET M3 includes a source coupled to an upper voltage rail VDD, a drain coupled to a drain and a gate of NFET M1, and a gate. The NFET M1 includes a source coupled to a lower voltage rail (e.g., ground). In this configuration, the NFET M1 is diode-connected.

The PFET M4 includes a source coupled to the upper voltage rail VDD, a gate coupled to the gate of PFET M3, and a drain. The resistor R1 is coupled between the drain of PFET M4 and drain and gate of NFET M2. The NFET M2 includes a source coupled to the lower voltage rail. In this configuration, the NFET M2 is diode-connected.

The operational amplifier 110 includes a first (e.g., negative) input coupled to a first node n1 at the drain of PFET M3 and drain/gate of NFET M1. The operational amplifier 110 includes a second (e.g., positive) input coupled to a second node n2 between the PFET M4 and the resistor R1. The operational amplifier 110 includes an output coupled to the gates of PFETs M3 and M4.

The PFET M5 includes a source coupled to the upper voltage rail VDD, a gate coupled to the gates of PFETs M3 and M4, and a drain. In this configuration, the PFETs M3, M4, and M5 form a current mirror. The resistor R2 is coupled between the drain of PFET M5 and the lower voltage rail. The PTAT current and/or voltage generator 100 is configured to generate an output voltage V_{OUT} at a node n3 between the PFET M5 and the resistor R2.

The size ratio between the PFET M3 and PFET M4 may be 1:1. The size ratio between the NFET M1 and M2 may be 1:m, where m may be significantly greater than one (1) (e.g., m=100). In this configuration, the current I_{D1} flowing through the PFET M3 and diode-connected NFET M1 is substantially equal to the current I_{D2} flowing through the PFET M4, resistor R1, and diode-connected NFET M2 due to the 1:1 size ratio between the PFETs M3 and M4 (e.g., I_{D1}=I_{D2}). Through feedback operation, the operational amplifier 110 provides a control voltage to the gates of the PFETs M3 and M4 to cause voltages V₁ and V₂ at respective nodes n1 and n2 to be substantially equal to each other (e.g., V₁=V₂).

Accordingly, the NFET M1 has a gate-to-source voltage V_{GS1} and drain-to-source voltage V_{DS1} substantially equal to V₁ and V₂ (e.g., V_{GS1}=V_{DS1}=V₁=V₂). The NFET M2 has a gate-to-source voltage V_{GS2} and drain-to-source voltage V_{DS2} substantially lower than the gate-to-source voltage V_{GS1} and drain-to-source voltage V_{DS1} of NFET M1 due to the I_{D2}*R1 voltage drop across the resistor R1. The difference in the gate-to-source voltages V_{GS1}-V_{GS2} is related to the PTAT output voltage V_{OUT} via the current mirroring performed by the PFETs M3-M5 to generate the output current I_{OUT} based on equal currents I_{D1}/I_{D2}. The output current I_{OUT} flows through the resistor R2 to generate the output voltage V_{OUT}. Accordingly, the PTAT output voltage V_{OUT} is related to the difference in the gate-to-source voltages V_{GS1}-V_{GS2}.

The difference in the gate-to-source voltages V_{GS1}-V_{GS2} may be approximated in accordance with the following equation:

$${V}_{G S 1} - {V}_{G S 2} = ( \frac{n {V}_{t}}{( 1 + n )} \frac{k}{q} ln ( m ) ) T + \frac{n {V}_{t}}{( 1 + n )} ln ( \frac{( 1 - exp ( \frac{- {V}_{DS 2}}{{V}_{t}} )}{( 1 - exp ( \frac{- {V}_{DS 1}}{{V}_{t}} )} ) \qquad Eq . 1$$

Where n is a FET-related constant, k is the Boltzmann constant (e.g., 1.380649×10⁻¹² joules per kelvin), q is the charge constant (e.g., 1.60×10⁻¹⁹ Coulomb charge), Vt is the threshold voltage of the NFETs M1 and M2, and T is temperature. Note that the term that is multiplied with temperature T is a constant as n, k, q, and m are constants. Thus, the output voltage V_{OUT}, which is related to V_{GS1}-V_{GS2}, varies linearly with temperature T with respect to the left-side of Eq. 1.

However, the output voltage V_{OUT} also varies with temperature in accordance with the right-side of Eq. 1. The reason being is that drain-to-source voltage V_{DS1} of NFET M1 is not equal to the drain-to-source V_{DS2} of NFET M2; and thus, the right-side has a finite value. Further, the right-side of Eq. 1 varies in a non-linear manner with temperature T. Accordingly, the output voltage V_{OUT} of the PTAT current and/or voltage generator 100 has a linear component (left-side of Eq. 1) and a non-linear component (right-side of Eq. 1).

FIG. 1B illustrates a graph of an output voltage V_{OUT} versus temperature associated with the PTAT current and/or voltage generator 100 in accordance with another aspect of the disclosure. The horizontal axis represents temperature in Celsius (° C.) ranging from −50° C. to 150° C. The vertical axis represents the output voltage V_{OUT} of the PTAT current and/or voltage generator 100 ranging from 100 milli Volts (mV) to 190 mV. The graph includes five (5) temperature variations of the output voltage V_{OUT} with different process corners: slow-slow (SS) indicated by a dash-dot line; slow-fast (SF) indicated by a long-dash line; typical-typical (TT) indicated by a solid line; fast-slow (FS) indicated by a medium-dash line; and fast-fast (FF) indicated by a short-dash lines.

The graph illustrates that for a temperature range from −50 C to about 70° C., the output voltage V_{OUT} varies substantially linear with temperature. This is due to the linear temperature component (left-side of Eq. 1) of the output voltage V_{OUT} dominating the non-linear temperature component (right-side of Eq. 1) of the output voltage V_{OUT}. However, above 70° C., the graph illustrates that the output voltage V_{OUT} begins to exhibit more of a non-linear variation due to the linear temperature component (left-side of Eq. 1) no longer dominating the non-linear temperature component (right-side of Eq. 1) of the output voltage V_{OUT}. The non-linearity of the output voltage V_{OUT} is more pronounced for the FS and FF process corners compared to the SS, SF, and TT process corners.

Nevertheless, it may be desirable to achieve a greater linearity of the output voltage V_{OUT} with temperature over an operating range (e.g., 50° C. to 150° C.) where calibration of the PTAT current and/or voltage generator 100 entails measuring the output voltage V_{OUT} at two temperature points along a substantially linear variation to determine its slope, using its slope with a current V_{OUT} reading to determine the current operating temperature.

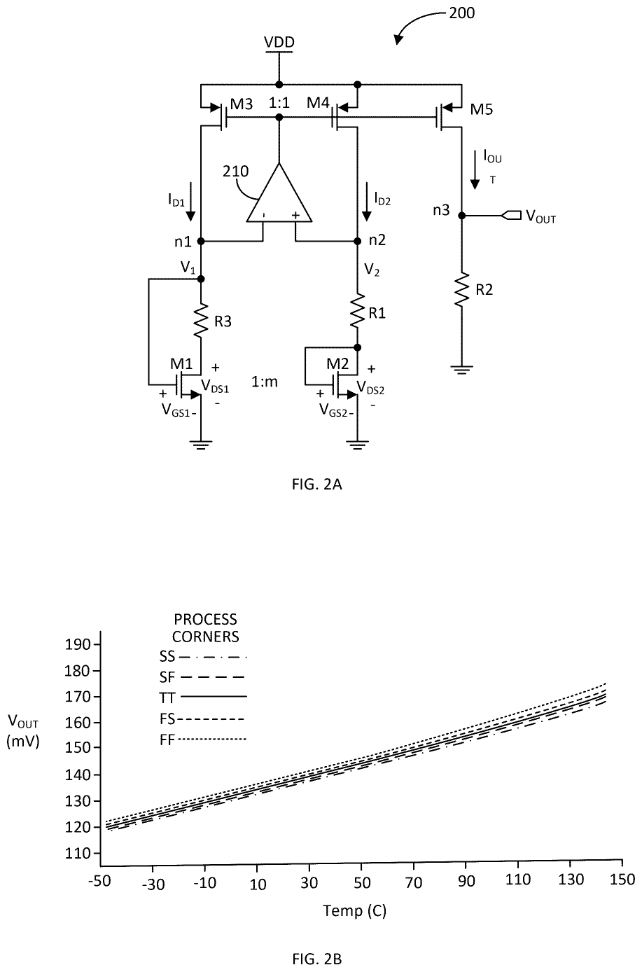

FIG. 2A illustrates a block diagram of another example temperature sensor 200 in accordance with another aspect of the disclosure. The temperature sensor 200 is similar to PTAT current and/or voltage generator 100 including many of the same elements as indicated by the same reference identifiers and reference numbers with the exception that its most significant digit is a “2” for PTAT current and/or voltage generator 200 instead of a “1” for PTAT current and/or voltage generator 100.

The PTAT current and/or voltage generator 200 differs from PTAT current and/or voltage generator 100 in that it includes a resistor R3 between node n1 (e.g., at the gate of NFET M1) and a drain of NFET M1. The resistor R3 may be configured to have the same resistance as the resistor R1. The purpose of the resistor R3 is to make the drain-to-source voltage V_{DS1} of the NFET M1 substantially equal to the drain-to-source voltage V_{DS2} of NFET M2. For example, the voltages V₁ and V₂ at respective nodes n1 and n2 are substantially equal (due to the feedback operation of the operational amplifier 210), and the currents I_{D1} and I_{D2} are substantially equal due to the 1:1 current mirror relationship of PFETs M3 and M4. Thus, the first drain-to-source voltage V_{DS1} is substantially equal to V₁−I_{D1}*R3 and the second drain-to-source voltage V_{DS2} is substantially equal to V₂−I_{D2}*R1. As V₁=V₂, I_{D1}=I_{D2}, and R3=R1, then V_{DS1}=V_{DS2}.

And if V_{DS1}=V_{DS2}, then per Eq. 1, the non-linear term (the right side) of Eq. 1 becomes zero (0) because the numerator and denominator in the natural logarithm (In) are substantially equal; and thereby, results in the natural logarithm (In) of one (1), which equals to zero (0). This eliminates the non-linear term of the output voltage V_{OUT}; thereby leaving only the linear term of the output voltage V_{OUT}. Accordingly, the addition of resistor R3 between the gate and drain of the NFET M1 improves the linearity of the output voltage V_{OUT} with temperature.

FIG. 2B illustrates a graph of an output voltage versus temperature associated with the PTAT current and/or voltage generator 200 in accordance with another aspect of the disclosure. Similarly, the horizontal axis represents temperature in Celsius (° C.) ranging from −50° C. to 150° C. The vertical axis represents the output voltage V_{OUT} of the PTAT current and/or voltage generator 200 ranging from 100 milli Volts (mV) to 190 mV. The graph includes five (5) temperature variations of the output voltage V_{OUT} with different process corners: slow-slow (SS) indicated by a dash-dot line; slow-fast (SF) indicated by a long-dash line; typical-typical (TT) indicated by a solid line; fast-slow (FS) indicated by a medium-dash line; and fast-fast (FF) indicated by a short-dash lines.

The graph illustrates that for the entire operating temperature range from −50 C to 150° C., the output voltage V_{OUT} varies substantially linear with temperature for the different process corners SS, SF, TT, FS, and FF. This is due to the elimination of the non-linear temperature component (right-side of Eq. 1) of the output voltage V_{OUT} by adding the resistor R3 and setting its resistance to substantially the same as the resistor of R1.

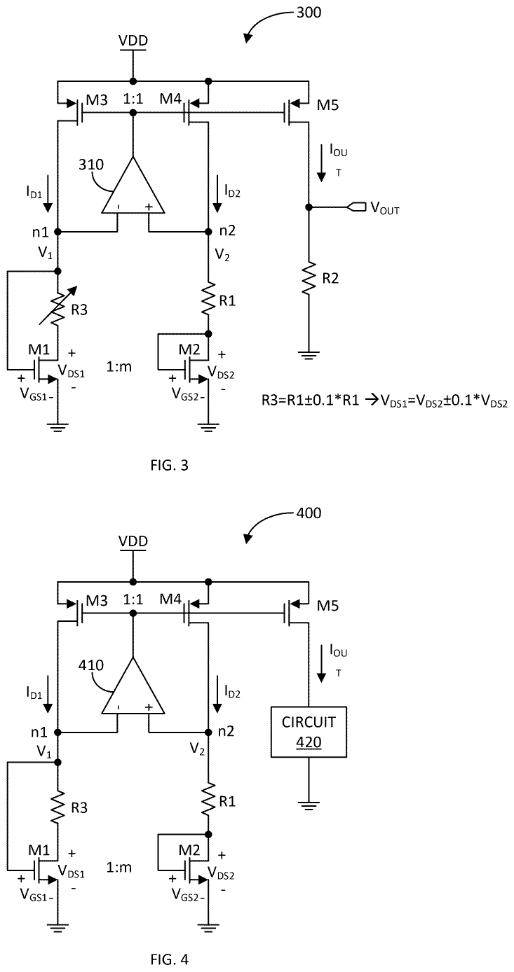

FIG. 3 illustrates a block diagram of another example PTAT current and/or voltage generator 300 in accordance with another aspect of the disclosure. The PTAT current and/or voltage generator 300 is similar to that of temperature sensor including many of the same elements as indicated by the same reference identifiers and reference numbers with the exception that its most significant digit is a “3” for PTAT current and/or voltage generator 300 instead of a “2” for PTAT current and/or voltage generator 200.

The PTAT current and/or voltage generator 300 differs from PTAT current and/or voltage generator 200 in that the resistor R3 is made variable (e.g., has a variable resistance). This may be done to vary the linearity based on the applicable process corner of the PTAT current and/or voltage generator 300. For example, if the process corner associated with the PTAT current and/or voltage generator 300 is the FF, then the resistance R3 may be set lower than the resistance R1 (e.g., by as much as 10 percent, R3=R1-0.1*R1). With reference to FIG. 2B, this lowers and more linearize the output voltage V_{OUT} for the FF corner. Or, if the process corner associated with the PTAT current and/or voltage generator 300 is the SS, then the resistance R3 may be set higher than the resistance R1 (e.g., by as much as 10 percent, R3=R1+0.1*R1). With reference to FIG. 2B, this increases and more linearize the output voltage V_{OUT} for the SS corner.

FIG. 4 illustrates a block diagram of another example PTAT current and/or voltage generator 300 in accordance with another aspect of the disclosure. The PTAT current and/or voltage generator 400 is similar to that of PTAT current and/or voltage generator 300 including many of the same elements as indicated by the same reference identifiers and reference numbers with the exception that its most significant digit is a “4” for PTAT current and/or voltage generator 400 instead of a “2” for PTAT current and/or voltage generator 200.

The PTAT current and/or voltage generator 400 differs from PTAT current and/or voltage generator 200 in that a circuit 420 is configured to receive the output current I_{OUT} to perform its operation. For example, the circuit 420 may be a ring oscillator (RO) including a set of cascaded current starved inverters arranged in a ring. The PTAT output current I_{OUT} may be used to stabilize the temperature variation of the clock signal generated by the RO. However, it shall be understood that the circuit 420 may include many different types of circuits.

FIG. 5 illustrates a block diagram of another example proportional to absolute temperature (PTAT) current and/or voltage generator 500 in accordance with another aspect of the disclosure. The PTAT current and/or voltage generator 500, includes: a first field effect transistor (FET) M3 including a first source coupled to a first voltage rail VDD, a first gate, and a first drain; a second FET M1 including a second drain, a second gate coupled to the first drain of the first FET M3, and a second source coupled to a second voltage rail (e.g., ground); and a first resistor R3 coupled between the second gate and the second drain of the second FET M1.

The PTAT current and/or voltage generator 500 further includes a third FET M4 including a third source coupled to the first voltage rail VDD, a third gate coupled to the first gate of the first FET M3, and a third drain; a fourth FET M2 including a fourth drain and a fourth gate coupled together, and a fourth source coupled to the second voltage rail (e.g., ground); a second resistor R1 coupled between the third drain of the third FET M4 and the fourth drain and fourth gate of the fourth FET M2; and a control circuit 510 configured to cause a first voltage V₁ at a first node n1 between the first FET M3 and the first resistor R3 to be substantially the same as a second voltage V₂ at a second node n2 between the third FET M3 and the second resistor R1. The operational amplifiers described herein may be one example of the control circuit 510. However, the control circuit 510 may be effectuated in different manners.

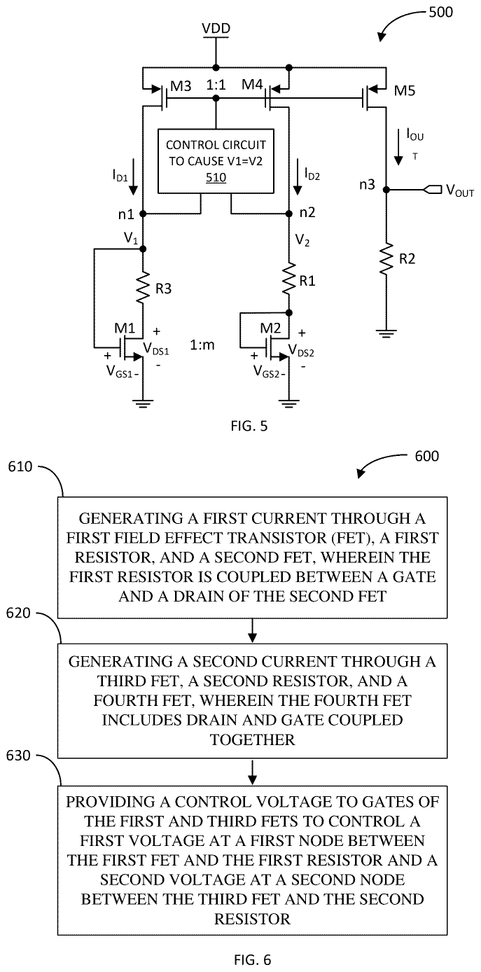

FIG. 6 illustrates a flow diagram of an example method 600 of generating a proportional to absolute temperature (PTAT) voltage or current in accordance with another aspect of the disclosure. The method 600 includes generating a first current through a first field effect transistor (FET), a first resistor, and a second FET, wherein the first resistor is coupled between a gate and a drain of the second FET (block 610). The method 600 further includes generating a second current through a third FET, a second resistor, and a fourth FET, wherein the fourth FET includes drain and gate coupled together (block 620). Additionally, the method 600 includes providing a control voltage to gates of the first and third FETs to control a first voltage at a first node between the first FET and the first resistor and a second voltage at second node between the third FET and the second resistor (block 630).

The following provides an overview of aspects of the present disclosure:

Aspect 1: An apparatus, comprising: a first field effect transistor (FET) including a first source coupled to a first voltage rail, a first gate, and a first drain; a second FET including a second drain, a second gate coupled to the first drain of the first FET, and a second source coupled to a second voltage rail; a first resistor coupled between the second gate and the second drain of the second FET; a third FET including a third source coupled to the first voltage rail, a third gate coupled to the first gate of the first FET, and a third drain; a fourth FET including a fourth drain and a fourth gate coupled together, and a fourth source coupled to the second voltage rail; a second resistor coupled between the third drain of the third FET and the fourth drain and fourth gate of the fourth FET; and a control circuit configured to cause a first voltage at a first node between the first FET and the first resistor to be substantially the same as a second voltage at a second node between the third FET and the second resistor.

Aspect 2: The apparatus of aspect 1, wherein the control circuit comprises an operational amplifier including a first input coupled to a first node between the first FET and the first resistor, a second input coupled to a second node between the third FET and the second resistor, and an output coupled to the first and third gates of the first and third FETs, respectively.

Aspect 3: The apparatus of aspect 1 or 2, wherein: the first voltage rail includes an upper voltage rail; the second voltage rail includes a lower voltage rail; the first and third FETs are each a p-channel field effect transistor; and the second and fourth FETs are each an n-channel field effect transistor.

Aspect 4: The apparatus of any one of aspects 1-3, wherein the first resistor has a resistance substantially the same as a resistance of the second resistor.

Aspect 5: The apparatus of any one of aspects 1-4, wherein the first resistor has a resistance within 10 percent of a resistance of the second resistor.

Aspect 6: The apparatus of any one of aspects 1-5, wherein the first resistor comprises a variable resistor.

Aspect 7: The apparatus of any one of aspects 1-6, wherein a size of the fourth FET is greater than a size of the second FET.

Aspect 8: The apparatus of any one of aspects 1-7, wherein a size of the first FET is substantially the same as a size of the third FET.

Aspect 9: The apparatus of any one of aspects 1-8, further comprising: a fifth FET including a fifth source coupled to the first voltage rail, a fifth gate coupled to the first and third gates of the first and third FETs, respectively, and a fifth drain; and a circuit coupled between the fifth drain of the fifth FET and the second voltage rail.

Aspect 10: The apparatus of aspect 9, wherein the circuit comprises a third resistor coupled between the fifth drain of the fifth FET and the second voltage rail.

Aspect 11: The apparatus of aspect 9 or 10, wherein: the first voltage rail includes an upper voltage rail; the second voltage rail includes a lower voltage rail; the first, third, and fifth FETs are each a p-channel field effect transistor; and the second and fourth FETs are each an n-channel field effect transistor.

Aspect 12: A method, comprising: generating a first current through a first field effect transistor (FET), a first resistor, and a second FET, wherein the first resistor is coupled between a gate and a drain of the second FET; generating a second current through a third FET, a second resistor, and a fourth FET, wherein the fourth FET includes drain and gate coupled together; and providing a control voltage to gates of the first and third FETs to control a first voltage at a first node between the first FET and the first resistor and a second voltage at a second node between the third FET and the second resistor.

Aspect 13: The method of aspect 12, wherein the first resistor has a resistance substantially the same as a resistance of the second resistor.

Aspect 14: The method of aspect 12 or 13, wherein the first resistor comprises a variable resistor.

Aspect 15: The method of any one of aspects 12-14, wherein the first resistor has a resistance within 10 percent of a resistance of the second resistor.

Aspect 16: The method of any one of aspects 12-15, wherein a size of the fourth FET is greater than a size of the second FET.

Aspect 17: The method of any one of aspects 12-16, wherein a size of the first FET is substantially equal to a size of the third FET.

Aspect 18: The method of any one of aspects 12-17, further comprising: mirroring the first current or the second current to generate a third current; and routing the third current to a circuit.

Aspect 19: The method of aspect 18, wherein routing the third current to the circuit comprises routing the third current to the circuit to generate an output voltage.

Aspect 20: The method of aspect 19, wherein the output voltage comprises a proportional to absolute temperature (PTAT) voltage.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a first field effect transistor (FET) including a first source coupled to a first voltage rail, a first gate, and a first drain;
a second FET including a second drain, a second gate coupled to the first drain of the first FET, and a second source coupled to a second voltage rail;
a first resistor coupled between the second gate and the second drain of the second FET;
a third FET including a third source coupled to the first voltage rail, a third gate coupled to the first gate of the first FET, and a third drain;
a fourth FET including a fourth drain and a fourth gate coupled together, and a fourth source coupled to the second voltage rail;
a second resistor coupled between the third drain of the third FET and the fourth drain and fourth gate of the fourth FET; and
a control circuit configured to cause a first voltage at a first node between the first FET and the first resistor to be substantially the same as a second voltage at a second node between the third FET and the second resistor.

2. The apparatus of claim 1, wherein the control circuit comprises an operational amplifier including a first input coupled to a first node between the first FET and the first resistor, a second input coupled to a second node between the third FET and the second resistor, and an output coupled to the first and third gates of the first and third FETs, respectively.

3. The apparatus of claim 1, wherein:
the first voltage rail includes an upper voltage rail;
the second voltage rail includes a lower voltage rail;
the first and third FETs are each a p-channel field effect transistor; and
the second and fourth FETs are each an n-channel field effect transistor.

4. The apparatus of claim 1, wherein the first resistor has a resistance substantially the same as a resistance of the second resistor.

5. The apparatus of claim 1, wherein the first resistor has a resistance within 10 percent of a resistance of the second resistor.

6. The apparatus of claim 1, wherein the first resistor comprises a variable resistor.

7. The apparatus of claim 1, wherein a size of the fourth FET is greater than a size of the second FET.

8. The apparatus of claim 1, wherein a size of the first FET is substantially the same as a size of the third FET.

9. The apparatus of claim 1, further comprising:
a fifth FET including a fifth source coupled to the first voltage rail, a fifth gate coupled to the first and third gates of the first and third FETs, respectively, and a fifth drain; and
a circuit coupled between the fifth drain of the fifth FET and the second voltage rail.

10. The apparatus of claim 9, wherein the circuit comprises a third resistor coupled between the fifth drain of the fifth FET and the second voltage rail.

11. The apparatus of claim 9, wherein:
the first voltage rail includes an upper voltage rail;
the second voltage rail includes a lower voltage rail;
the first, third, and fifth FETs are each a p-channel field effect transistor; and
the second and fourth FETs are each an n-channel field effect transistor.

12. A method, comprising:
generating a first current through a first field effect transistor (FET), a first resistor, and a second FET, wherein the first resistor is coupled between a gate and a drain of the second FET;
generating a second current through a third FET, a second resistor, and a fourth FET, wherein the fourth FET includes drain and gate coupled together; and
providing a control voltage to gates of the first and third FETs to control a first voltage at a first node between the first FET and the first resistor and a second voltage at a second node between the third FET and the second resistor.

13. The method of claim 12, wherein the first resistor has a resistance substantially the same as a resistance of the second resistor.

14. The method of claim 12, wherein the first resistor comprises a variable resistor.

15. The method of claim 12, wherein the first resistor has a resistance within 10 percent of a resistance of the second resistor.

16. The method of claim 12, wherein a size of the fourth FET is greater than a size of the second FET.

17. The method of claim 12, wherein a size of the first FET is substantially equal to a size of the third FET.

18. The method of claim 12, further comprising:
mirroring the first current or the second current to generate a third current; and
routing the third current to a circuit.

19. The method of claim 18, wherein routing the third current to the circuit comprises routing the third current to the circuit to generate an output voltage.

20. The method of claim 19, wherein the output voltage comprises a proportional to absolute temperature (PTAT) voltage.
